(19) United States
(12) Patent Application Publication
(10) Pub. No.: US 2021/0350241 A1
(43) Pub. Date: Nov. 11, 2021

(54) APPARATUS AND METHOD FOR SEARCHING FOR A NEURAL NETWORK ARCHITECTURE

(71) Applicant: ELECTRONICS AND TELECOMMUNICATIONS RESEARCH INSTITUTE, Daejeon (KR)

(72) Inventors: Seungjae LEE, Daejeon (KR); Jong-Gook KO, Daejeon (KR); Keun Dong LEE, Daejeon (KR); Su Woong LEE, Sejong-si (KR); Yongsik LEE, Busan (KR); Da-Un JUNG, Goyang-si (KR); Wonyoung YOO, Daejeon (KR)

(21) Appl. No.: 17/242,604

(22) Filed: Apr. 28, 2021

(30) Foreign Application Priority Data
May 6, 2020 (KR) 10-2020-0053894

(51) Int. Cl. G06N 3/08; G06N 3/04

(52) U.S. Cl. CPC G06N 3/082; G06N 3/04

(57) ABSTRACT

An apparatus and method for searching a neural network architecture may be disclosed. The apparatus may include an architecture searcher and an architecture evaluator. The architecture searcher may search for a topology between nodes included in a basic cell of a network, search for an operation to be applied between the nodes after searching for the topology, and determine the basic cell. The architecture evaluator may evaluate performance of the determined basic cell.

### CROSS-REFERENCE TO RELATED APPLICATION

This application claims priority to and the benefit of Korean Patent Application No. 10-2020-0053894 filed in the Korean Intellectual Property Office on May 6, 2020, the entire content of which is incorporated herein by reference.

### BACKGROUND OF THE INVENTION

### 1. Field of the Invention

The following description relates to an apparatus and method for searching a neural network architecture.

### 2. Description of Related Art

A neural network architecture search automatically finds a network structure used for deep learning through machine learning, not through expert design and experimentation. For this neural network architecture search, the initially proposed method constructs a model for selecting an operation and a network structure, samples the operation and the structure from the model, and learns and evaluates the selected structure. According to the evaluation result, the model for selecting a network structure is updated, and this process is repeated until a network structure that satisfies the target performance is found. This method has a disadvantage that it is difficult to use in practical applications because it requires a large amount of computation. To improve this, a method of modifying the search of the entire network structure has been proposed. This method defines a network for evaluation and searches for a basic structural unit, that is, a cell, for composing the defined network. This method can reduce the amount of computation by narrowing the search range, but still requires a lot of computation and memory to learn and evaluate new networks.

Recently, various methods have been proposed to improve this method. Among the recent methods, a differential architecture search (Liu, Hanxiao, Karen Simonyan, and Yiming Yang, “Darts: Differentiable architecture search” arXiv preprint arXiv:1806.09055 (2018)) changes a categorical selection to a differentiable architecture, which considers all operations and connections through continuous relaxation using a softmax function, for the operation and connectivity required for network search. For an integrated network, such a differential architecture search method divides a parameter of the operation and a connection parameter of the operation into training data and validation data, performs learning through a bi-level optimization method, and determines the network architecture based on the learned parameters.

Since the differential architecture search method utilizes a differentiable architecture, the network architecture can be determined in a short time, but different results may appear due to random variable initialization during the learning process. The differential architecture search method additionally requires a selection process through learning to select the final architecture. The differential architecture search method requires a lot of memory because it learns all connectable operations to find a basic cell of the network. In addition, the differential architecture search method evaluates the network with a low depth rather than configuring the entire network for evaluation, and uses a method of configuring the entire network in the final evaluation, so there is a difference from the actual optimal performance. Since the method of determining the basic cell in the learning process selects only the operation with the largest value based on the parameter of the learned operation, there is a difference between the operation used during learning and the operation selected for the network. Meanwhile, in recent years, as the number of skip-connection operations increases during the learning process, there is a problem that overall performance is deteriorated.

The above information disclosed in this Background section is only for enhancement of understanding of the background of the invention, and therefore it may contain information that does not form the prior art that is already known in this country to a person of ordinary skill in the art.

### SUMMARY OF THE INVENTION

At least one embodiment may provide an apparatus and method for searching a neural network architecture that can search for a new architecture with a small amount of memory and computation.

At least one embodiment may provide an apparatus and method for searching neural network architecture that can reduce performance degradation due to a parameterless operation.

In one aspect, an apparatus for searching a neural network architecture may be provided. The apparatus may include an architecture searcher configured to search for a topology between nodes included in a basic cell of the neural network, search for an operation to be applied between the nodes after searching for the topology, and determine the basic cell; and an architecture evaluator configured to evaluate a performance of the determined basic cell.

The architecture searcher may include a topology searcher configured to determine whether to connect the nodes to each other, and an operation searcher configured to gradually determine the operation to be applied between the nodes after the topology searcher searches for the topology.

The topology searcher may set connection and disconnection as parameters and determine whether to connect to each other between the nodes through learning.

The operation searcher may configure a first basic cell to which all operations connectable to a first node are applied, determine a first operation to be connected to the first node by performing learning on the first basic cell, configure a second basic cell in which the first operation is applied to the first node and the all operations are applied to the second node after determining the first operation of the first node, and determine a second operation to be connected to the second node by performing learning on the second basic cell.

All the operations may be operations excluding a parameter-free operation.

The parameter-free operation may be at least one of skip-connection, max-pooling, and average-pooling.

In another aspect, a method for searching a neural network architecture may be provided. The method may include searching for a topology between a plurality of nodes included in a basic cell of the network; and gradually searching for an operation to be applied between the plurality of nodes after the searching for the topology.

The searching for the topology may include determining the topology indicating whether or not the plurality of nodes are connected to each other.

The gradually searching for the operation may include sequentially searching for the operation to be applied between the plurality of nodes from a node close to an input node among the plurality of nodes.

The determining may include setting connection and disconnection as parameters, and determining whether to connect to each other between the plurality of nodes through learning.

The operation may be an operation excluding a parameter-free operation.

The parameter-free operation may be at least one of skip-connection, max-pooling, and average-pooling.

In another aspect, a method for searching a neural network architecture may be provided. The method may include providing first to third nodes included in a basic cell of a network; determining a topology indicating whether the second node and the first node are connected, whether the third node and the second node are connected, and whether the third node and the first node are connected; determining a first operation to be applied between the second node and the first node after determining the topology; and determining a second operation to be applied between the third node and the second node after determining the first operation.

The method may further include determining a third operation to be applied between the third node and the first node after determining the first operation.

The determining the first operation may include configuring a first basic cell to which all operations connectable between the second node and the first node are applied, and determining the first operation among all operations by performing learning on the first basic cell.

The determining the second operation may include: configuring a second basic cell in which the first operation is applied between the second node and the first node, and all operation are applied between the third node and the second node; and determining the second operation among all operations by performing learning on the second basic cell.

All operations may be operations excluding a parameter-free operation.

According to at least one embodiment, by determining topology first and then gradually determining an operation, it is possible to reduce search time and memory use.

According to at least one embodiment, by excluding a parameter-free operation when selecting an operation, stable performance and architecture can be selected.

### BRIEF DESCRIPTION OF THE DRAWINGS

FIG. 1 is a block diagram showing an apparatus for searching a neural network according to one embodiment.

FIG. 2 is a diagram showing a topology search method of a topology searcher according to one embodiment.

FIG. 3 is a diagram showing an operation search method of an operation searcher according to one embodiment.

FIG. 4 is an experimental graph comparing memory and computation amounts for a method according to one embodiment and existing methods.

FIG. 5 is a diagram showing a performance comparison of a method according to one embodiment and existing methods.

FIG. 6 is a diagram showing a computer system according to one embodiment.

### DETAILED DESCRIPTION OF THE EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness. The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein, the term “and/or” includes any one and any combination of any two or more of the associated listed items. Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples. Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly. The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. The features of the examples described herein may be combined in various ways as will be apparent after an understanding of the disclosure of this application. Further, although the examples described herein have a variety of configurations, other configurations are possible as will be apparent after an understanding of the disclosure of this application. In addition, unless explicitly described to the contrary, the word “comprise” and variations such as “comprises” or “comprising” will be understood to imply the inclusion of stated elements but not the exclusion of any other elements.

A method of searching a network for deep learning according to one embodiment may utilize a method applied to an existing differentiable architecture other than the method described below. A specific method for the existing differentiable architecture can be known to those of ordinary skill in the art, and a detailed description thereof will be omitted. In the method for searching a neural network architecture according to one embodiment, when searching for basic architecture (basic cell), unlike the existing differentiable architecture, a topology is first searched. An operation is progressively searched based on the determined (searched) topology. Here, the searched basic unit (cell) may be composed of a Directed Acyclic Graph (DAC).

Throughout the specification, the basic architecture (basic cell) is described as having an architecture in which two inputs, N middle nodes, and one output are included, and the output receives and transmits the outputs of the middle nodes, but other existing architecture may be applied. For the basic architecture (basic cell) constructed in this way, whether or not to connect each node and through which operation are the main key points. Meanwhile, in at least one embodiment, a basic architecture (basic cell) is divided into a normal cell and a reduction cell, and the entire network for evaluation can be configured using these normal cell and reduction cell.

The existing differentiable architecture connects all connectable operations when searching for a basic architecture (basic cell) of the network, obtains the probability of being connected through learning, and selects the operation with the highest probability based on this. In this process, since the topology and the operation are determined at the same time, the existing differentiable structure may result in unstable search results, resulting in poor performance. For example, if three operations (e.g., OP1, OP2, and OP3) are in a competitive relationship and the probability of the operations for learning is evenly distributed, the entire network by the three operations can reduce the loss in the learning process. However, in the architecture to be finally determined, one of the three operations may be selected and performance different from the learning process may appear. In addition, in this method, performance degradation may occur due to a parameter-free operation such as a skip-connection. In the basic unit (cell), when determining topology and operation, the intermediate node loses the expressive power of features by the learning process as it moves away from the input node. Accordingly, a phenomenon of directly connecting the information of the immediately preceding node or the input node may occur. As a result, the number of skip-connections, etc. may increase and performance may be degraded.

Unlike the existing differentiable architecture, the method for searching a neural network architecture according to one embodiment first searches (selects) a topology and gradually searches for an operation for each node based on the searched topology. Through this, the method for searching a neural network architecture according to one embodiment can reduce memory and computational amount. In addition, in the method for searching a neural network architecture according to one embodiment, performance degradation can be reduced by excluding a parameter-free operation from operation selection. Hereinafter, a method for searching a neural network architecture according to one embodiment will be described in detail.

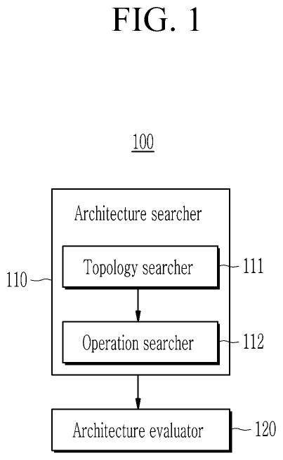

FIG. 1 is a block diagram showing an apparatus for searching a neural network architecture 100 according to one embodiment.

As shown in FIG. 1, the apparatus for searching a neural network architecture 100 according to one embodiment includes an architecture searcher 110 and an architecture evaluator 120. The architecture searcher 110 searches for a basic architecture (basic cell), and the architecture evaluator 120 configures an entire network based on the basic architecture (basic cell) searched by the architecture searcher 110 to perform evaluation.

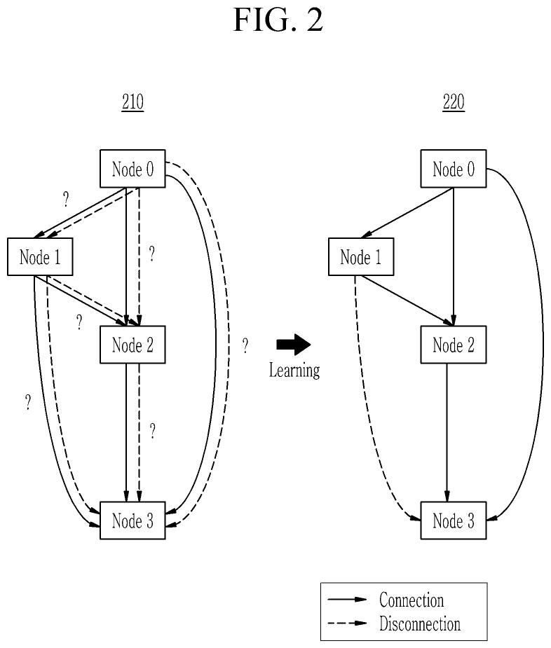

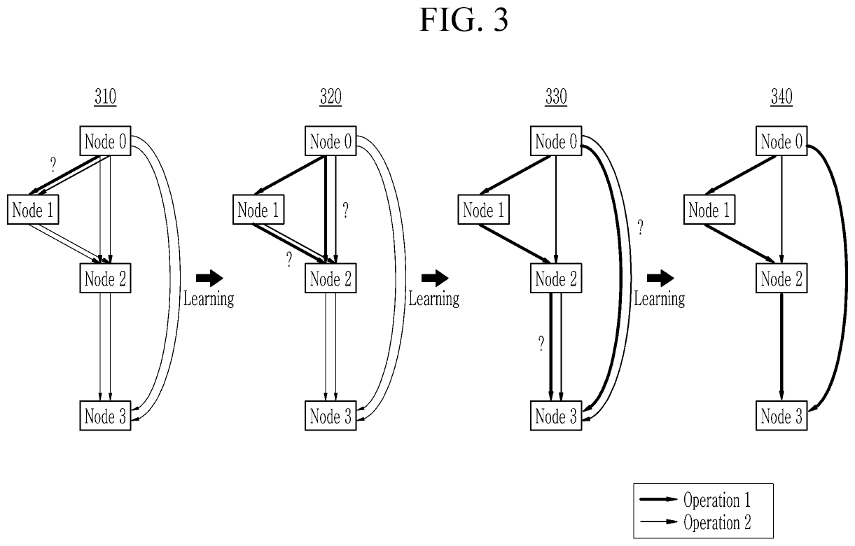

Referring to FIG. 1, the architecture searcher 110 according to one embodiment includes a topology searcher 111 and an operation searcher 112. The topology searcher 111 first searches (determines) a topology, and the operation searcher 112 next progressively searches (determines) an operation. That is, the architecture searcher 110 according to one embodiment first searches (determines) a topology, and gradually searches for an operation for each node based on the searched (determined) topology. A detailed operation method of the architecture searcher 110 will be described in more detail with reference to FIGS. 2 and 3 below.

First, with reference to FIG. 2, a topology search method of the topology searcher 111 according to one embodiment will be described.

FIG. 2 is a diagram showing a topology search method of a topology searcher 111 according to one embodiment.

In FIG. 2, 210 denotes a state before the topology search of the topology searcher 111 is applied, and each node is in a state in which connection and disconnection are not determined. Further, 220 denotes a state after the topology searcher 111 searches (determines) topology, and each node is in a state in which connection and disconnection are determined. In FIG. 2, for convenience of explanation, it is assumed that the number of nodes is four, but the number of nodes may be changed.

The topology searcher 111 determines (searches) whether to connect to each node such as 210 of FIG. 2. To this end, the topology searcher 111 sets connection and disconnection as parameters, and determines whether to connect by performing learning using training data to be used in the neural network (e.g., a training data set and an evaluation data set for image classification).

A method in which the topology searcher 111 determines whether to connect through learning will be described as follows. The topology searcher 111 performs learning using the training data, assuming that all nodes are connected with a uniform probability (for example, 1/2 probability). At this time, the topology searcher 111 learns parameters of nodes (e.g., filter coefficients) and simultaneously learns the connectivity parameters. Meanwhile, since performing two learnings at the same time has a bi-level optimization problem, the topology searcher 111 learns the parameters of nodes (filter coefficients) using the training data set, and learns a parameter for connectivity using a validation data set. A more detailed description of such a learning method will be omitted as it can be known to those of ordinary skill in the art to which the present invention pertains.

When the topology searcher 111 determines whether to connect through learning, connectivity (topology) as shown in 220 of FIG. 2 is determined. Referring to 220 of FIG. 2, node 0 and node 1 are connected to each other, node 1 and node 2 are connected to each other, node 2 and node 3 are connected to each other, and node 0 and node 3 are connected to each other. And node 1 and node 3 are disconnected.

After the topology searcher 111 searches (determines) topology (connectivity), the operation searcher 112 gradually searches (determines) an operation (operator). The operation search method of the operation searcher 112 will be described with reference to FIG. 3 below.

FIG. 3 is a diagram showing an operation search method of an operation searcher 112 according to one embodiment.

The operation searcher 112 performs operation search after applying the connectivity (topology) determined in FIG. 2 to the basic cell (basic architecture).

The operation searcher 112 gradually determines (searches) an operation (operator) from a node close to the input. Here, the operation searcher 112 uses an operation excluding parameter-free operations such as skip-connection, max-pooling, average-pooling, etc. In FIG. 3, operations that are not parameter-free operations are represented by operation 1 and operation 2.

First, referring to 310 of FIG. 3, the operation searcher 112 performs an operation search on node 1, which is a first node. That is, the operation searcher 112 searches for an operation (operator) to be applied between node 0 and node 1. The operation searcher 112 configures operators 1 and 2, which are all operators (excluding parameter-free operators) that can be connected to node 1, and considers them as a basic architecture (basic cell) to configure a network, and determines an operation to be connected to node 1 through learning. Accordingly, an operation (operator) applied between node 0 and node 1 may be determined as operation 1.

Referring to 320 of FIG. 3, the operation searcher 112 performs an operation search on node 2, which is a second node. That is, the operation searcher 112 searches for an operation to be applied between node 1 and node 2 and an operation to be applied between node 0 and node 2. The operation searcher 112 configures operators 1 and 2, which are all operators (excluding parameter-free operators) that can be connected to node 2, and considers them as a basic architecture (basic cell) to configure a network, and determines an operation to be connected to node 2 through learning. At this time, between node 0 and node 1, the previously determined operation (i.e., operator 1) is applied to the basic architecture (cell). Accordingly, an operation (operator) applied between node 1 and node 2 may be determined as operation 1 and an operation (operator) applied between node 0 and node 2 may be determined as operation 2.

Referring to 330 of FIG. 3, the operation searcher 112 performs an operation search on node 3, which is a third node. That is, the operation searcher 112 searches for an operation to be applied between node 2 and node 3 and an operation to be applied between node 0 and node 3. The operation searcher 112 configures operators 1 and 2, which are all operators (excluding parameter-free operators) that can be connected to node 3, and considers them as a basic architecture (cell) to configure a network, and determines an operation to be connected to node 3 through learning. At this time, the previously determined operations are applied to the basic architecture (cell) in node 1 and node 2. Accordingly, an operation (operator) applied between node 2 and node 3 may be determined as operation 1 and an operation (operator) applied between node 0 and node 3 may be determined as operation 1.

This process is repeated until all node operations (operators) are determined. 340 of FIG. 3 shows the finally determined operations for each node. The architecture searcher 110 sets the determined topology (connectivity) and operation (operator) as shown in FIGS. 2 and 3 as a basic architecture (cell).

Here, a method of determining an operation through learning by the operation searcher 112 is as follows. The operation searcher 112 connects all connectable operations (operators) (excluding the parameter-free operation) to the first node (node 1) and learns a parameter indicating an importance of the operations. That is, the operation searcher 112 learns a filter (filter coefficient) of a neural network and learns a parameter indicating the importance of the operation, and through such learning, a probability value for the connectivity of the operation may be obtained. The operation searcher 112 selects an operation based on the obtained probability value. For example, the operation searcher 112 connects all four operators and sets them to a probability of 0.25, then performs learning, and selects one operation having the greatest probability after learning. After determining the operation for the first node, the operation searcher 112 determines the operation for the next node through learning in the same manner as described above. A more detailed description of such a learning method will be omitted as it can be known to those of ordinary skill in the art to which the present invention pertains.

Meanwhile, the architecture evaluator 120 configures a final entire network based on the architecture (a basic cell) finally set in the architecture searcher 110 and evaluates the performance. The architecture searcher 110 constructs a neural network having a low depth when searching for architecture (for example, in the case of CIFAR-10, 8 cells (6 normal cells, 2 reduction cells)), and determines the architecture through learning. The architecture evaluator 120 constructs a deeper neural network architecture (e.g., 20 cells in the case of CIFAR-10) than the architecture determined by the architecture searcher 110, and then performs the evaluation.

According to such an embodiment, by determining topology first and then gradually determining an operation, it is possible to reduce search time and memory use. According to one embodiment, by excluding a parameter-free operation when selecting an operation, stable performance and architecture can be selected.

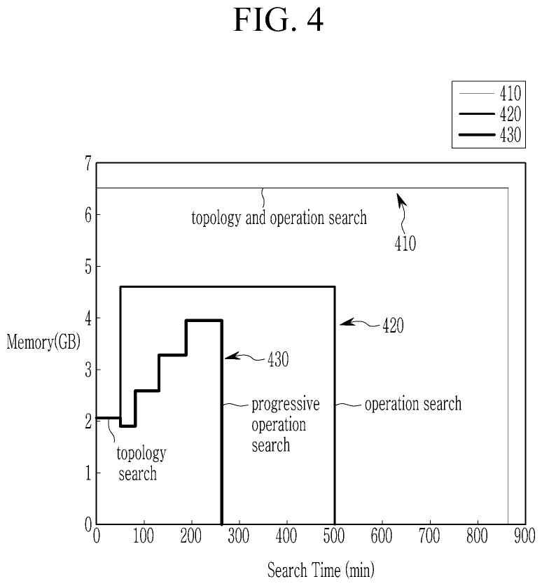

FIG. 4 is an experimental graph comparing memory and computation amounts for a method according to one embodiment and an existing method.

In FIG. 4, 410 denotes a case in which a topology and an operation are determined at the same time as in a differentiable architecture that is an existing method (hereinafter referred to as ‘existing method 1’), and 420 denotes a case where a topology is first searched and an operation is searched as in an existing art (i.e., an operation is searched at the same time without gradually searching for an operation) (hereinafter referred to as “existing method 2”). And 430 denotes a case where a topology is first searched and then an operation is determined for each node through learning as in one embodiment (hereinafter referred to as “method according to one embodiment”). In FIG. 4, CIFAR (Canadian Institute For Advanced Research)-10 data was applied for the performance experiment.

Referring to 410 and 430 in FIG. 4, it can be seen that the method according to one embodiment takes less memory and computation time than the existing method 1. Meanwhile, referring to 410 and 420 of FIG. 4, since the existing method 2 searches for topology first, it is possible to reduce memory and search time. However, it can be seen that the existing method 2 is not more efficient than the case of progressively searching for an operation like the method according to one embodiment.

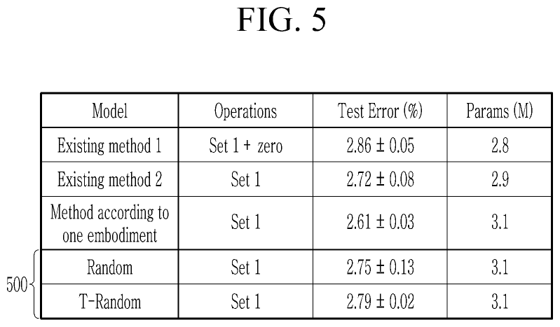

FIG. 5 is a diagram showing a performance comparison of a method according to one embodiment and existing methods.

In FIG. 5, CIFAR-10 data is applied to the existing method 1, the existing method 2, and the method according to one embodiment, respectively. In FIG. 5, 500 denotes a performance comparison result for a case of random operation selection rather than learning (Random) and a case of random operation selection considering topology (T-Random). FIG. 5, Set 1 is a set of operations configured for an experiment, and as an example, it may be 1×1, 3×3, 5×5, and 7×7 separable convolutions (single). In addition, in FIG. 5, M denotes an amount of a parameter for network configuration, and may be an amount of a parameter such as convolution used for network connection.

Referring to FIG. 5, it can be seen that the method according to one embodiment has superior performance compared to the existing methods 1 and 2. That is, it can be seen that the method according to one embodiment has the smallest test error and the smallest deviation of the error. This result can be understood as a result of first determining a topology and gradually selecting an operation, as in the method according to one embodiment.

Meanwhile, the method according to one embodiment was also evaluated for performance in ImageNet, and the Top-5/Top-1 test error rate was 24.2/7.2%. And it took 0.2 GPU days based on Titan xp (PASCAL) GPU to find this structure. Accordingly, it can be seen that the method according to one embodiment shows a large amount of computation reduction and excellent performance compared to the existing methods. Meanwhile, the existing NASNet-A has a test error rate of 26/8.4% through 1800 GPU days, AmoebaNet-C has a test error rate of 24.5/7.6% through 3150 GPU days, and the differentiable architecture (the existing method 1) has a test error rate of 26.7/8.7% through 4 GPU days.

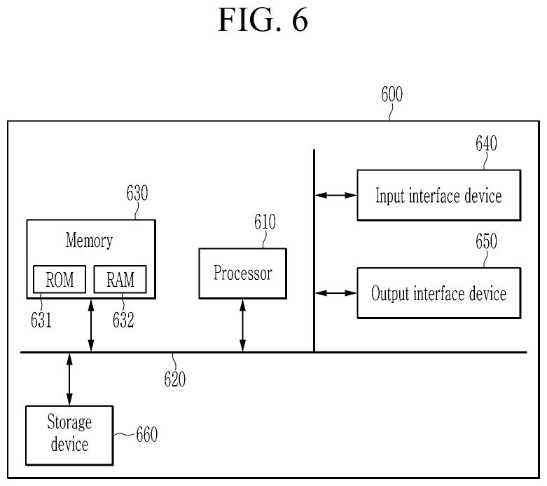

FIG. 6 is a diagram showing a computer system 600 according to one embodiment.

The apparatus for searching a neural network architecture 100 according to one embodiment may be implemented in the computer system 600 of FIG. 6. Each component of the apparatus for searching a neural network architecture 100 can also be implemented in the computer system 600 of FIG. 6.

The computer system 600 may include at least one of a processor 610, a memory 630, an input interface device 640, an output interface device 650, and a storage device 660, that communicate via a bus 620.

The processor 610 may be a central processing (CPU) or a semiconductor device that executes instructions stored in the memory 630 or the storage device 660. The processor 610 may be configured to implement the functions and methods described in FIG. 1 to FIG. 3.

The memory 630 and the storage device 660 may include various forms of volatile or non-volatile storage media. For example, the memory 630 can include a read only memory (ROM) 831 and a random access memory (RAM) 632. In one embodiment, the memory 630 may be located inside or outside the processor 610, and the memory 630 may be coupled to the processor 810 through various already-known means. While this disclosure includes specific examples, it will be apparent after understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for searching a neural network architecture, the apparatus comprising:
an architecture searcher configured to search for a topology between nodes included in a basic cell of network, search for an operation to be applied between the nodes after searching for the topology, and determine the basic cell; and
an architecture evaluator configured to evaluate performance of the determined basic cell.

2. The apparatus of claim 1, wherein the architecture searcher includes:
a topology searcher configured to determine whether to connect the nodes to each other; and
an operation searcher configured to gradually determine the operation to be applied between the nodes after the topology searcher searches for the topology.

3. The apparatus of claim 2, wherein the topology searcher sets connection and disconnection as parameters and determines whether to connect to each other between the nodes through learning.

4. The apparatus of claim 2, wherein the operation searcher configures a first basic cell to which all operations connectable to a first node are applied, determines a first operation to be connected to the first node by performing learning on the first basic cell, configures a second basic cell in which the first operation is applied to the first node and all operations are applied to the second node after determining the first operation of the first node, and determines a second operation to be connected to the second node by performing learning on the second basic cell.

5. The apparatus of claim 4, wherein all operations are operations excluding a parameter-free operation.

6. The apparatus of claim 5, wherein the parameter-free operation is at least one of skip-connection, max-pooling, and average-pooling.

7. A method for searching a neural network architecture, the method comprising:
searching for a topology between a plurality of nodes included in a basic cell of a network; and
gradually searching for an operation to be applied between the plurality of nodes after the searching for the topology.

8. The method of claim 7, wherein the searching for the topology includes determining the topology indicating whether or not the plurality of nodes are connected to each other.

9. The method of claim 7, wherein the gradually searching for the operation includes sequentially searching for the operation to be applied between the plurality of nodes from a node close to an input node among the plurality of nodes.

10. The method of claim 8, wherein the determining includes:
setting connection and disconnection as parameters; and
determining whether to connect to each other between the plurality of nodes through learning.

11. The method of claim 7, wherein the operation is an operation excluding a parameter-free operation.

12. The method of claim 11, wherein the parameter-free operation is at least one of skip-connection, max-pooling, and average-pooling.

13. A method for searching a neural network architecture, the method comprising:
providing a first to third nodes included in a basic cell of a network;
determining a topology indicating whether the second node and the first node are connected, whether the third node and the second node are connected, and whether the third node and the first node are connected;
determining a first operation to be applied between the second node and the first node after determining the topology; and
determining a second operation to be applied between the third node and the second node after determining the first operation.

14. The method of claim 13, further comprising determining a third operation to be applied between the third node and the first node after determining the first operation.

15. The method of claim 13, wherein the determining the first operation includes:
configuring a first basic cell to which all operations connectable between the second node and the first node are applied; and
determining the first operation among all operations by performing learning on the first basic cell.

16. The method of claim 15, wherein the determining the second operation includes:
configuring a second basic cell in which the first operation is applied between the second node and the first node, and all operation are applied between the third node and the second node; and
determining the second operation among all operations by performing learning on the second basic cell.

17. The method of claim 16, wherein all operations are operations excluding a parameter-free operation.
